(19) United States
(12) Patent Application Publication
(10) Pub. No.: US 2005/0007441 A1
(43) Pub. Date: Jan. 13, 2005

(54) Exposure head and exposure apparatus

(75) Inventor: Hiroaki Hyuga, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/886,120

(22) Filed: Jul. 8, 2004

(30) Foreign Application Priority Data
Jul. 9, 2003 (JP) 194250/2003

(51) Int. Cl. B41J 2/45

(52) U.S. Cl. 347/238

(57) ABSTRACT

An exposure head, which is capable of sufficiently increasing pixel density without particularly decreasing the size of the light emitting elements of a planar light emitting element array, while being small in size itself. Linear light emitting element arrays are constituted by a plurality of light emitting elements, which are arranged in a main scanning direction at a predetermined pitch. A plurality of the linear light emitting element arrays are arranged in a sub scanning direction, which is substantially perpendicular to the main scanning direction, to constitute a planar light emitting element array. The sizes a and b of the light emitting elements in the main and sub scanning directions, respectively, and the arrangement pitches P1 and P2 in the main and sub scanning directions, respectively, satisfy the relationships P1≦2a and P2≦2b.

### BACKGROUND OF THE INVENTION

1. Field of the Invention

The present invention relates to an exposure head for exposing photosensitive material. Particularly, the present invention relates to an exposure head that employs planar light emitting element arrays.

The present invention also relates to an exposure apparatus, for exposing two dimensional images on photosensitive material, employing the aforementioned exposure head.

2. Description of the Related Art

There are known exposure heads employing planar light emitting element arrays, comprising a plurality of linear light emitting element arrays, which are arranged in a sub scanning direction. The linear light emitting element arrays comprise a plurality of light emitting elements, which are arranged in a main scanning direction substantially perpendicular to the sub scanning direction, at a predetermined pitch. Photosensitive materials are exposed by the light, emitted from the light emitting elements of the array. Recently, various exposure heads that employ organic EL (Electro-Luminescence) elements have also been proposed.

There are also known exposure apparatuses that expose two dimensional images on photosensitive material, by moving an exposure head comprising a planar light emitting element and the photosensitive material relative to each other, to perform sub scanning. U.S. Patent Laid-Open No. 20010052926 discloses an example of this type of exposure apparatus.

Regarding the aforementioned exposure heads constituted by planar light emitting element arrays, it is desirable that the number of light emitting elements in both the main and sub scanning directions are increased, in order to expose highly detailed images. However, if this configuration is adopted, the size of the planar light emitting element arrays is increased. Therefore, regions of exposure apparatuses, at which the photosensitive materials are required to be maintained in a flat state, also increase in size. Accordingly, problems arise in that the number of apparatus adjustment steps, the size of the apparatus, and the cost of the apparatus also increase.

Increasing the pixel density of the planar light emitting element arrays, by decreasing the size (light emitting area) of each light emitting element may be considered, in order to prevent these problems. However, if the size of the light emitting elements is simply decreased, the brightness required of the emitted light is increased, in order to secure the necessary amount of exposure light. This leads to an increase in the amount of generated heat, which in turn leads to a reduction in the durability of the light emitting elements.

### SUMMARY OF THE INVENTION

The present invention has been developed in view of the aforementioned problems. It is an object of the present invention to provide an exposure head, which is capable of sufficiently increasing pixel density without particularly decreasing the size of the light emitting elements of a planar light emitting element array, while being small in size itself.

It is another object of the present invention to provide a small, low cost exposure apparatus, which is capable of exposing highly detailed images.

The exposure head for exposing photosensitive material according to the present invention comprises:
a plurality of linear light emitting element arrays, in each of which a plurality of light emitting elements are arranged in a main scanning direction at a predetermined pitch; and
a planar light emitting element array, comprising the plurality of linear light emitting element arrays, which are arranged in a sub scanning direction substantially perpendicular to the main scanning direction; wherein the size a of each light emitting element in the main scanning direction and the pitch P1, at which they are arranged in the main scanning direction, satisfy the relationship:
P1≦2a; and
the size b of each light emitting element in the sub scanning direction and the pitch P2, at which they are arranged in the sub scanning direction, satisfy the relationship:
P2≦2b. That is, the gaps between the light emitting elements is smaller than the sizes thereof, in both the main and sub scanning directions.

Note that it is preferable that the exposure head satisfy the relationships a<b and P1=b. That is, it is preferable that the size of the light emitting elements is larger in the sub scanning direction than in the main scanning direction, while the arrangement pitch in the main scanning direction is equal to the size of the light emitting elements in the sub scanning direction.

It is also desirable that at least a portion of the light emitting elements of adjacent linear light emitting element arrays are shifted and overlap in the main scanning direction.

In addition, it is preferable that:
a plurality of the planar light emitting element arrays, each having light emitting elements that emit light at different spectrums, are employed; and
the plurality of planar light emitting element arrays are arranged in the sub scanning direction. In this case, it is particularly preferable that:
the spectrums of light emitted from the light emitting elements of the planar light emitting element arrays are in the R (red), G (green), and B (blue) regions, respectively.

Further, organic EL elements may be favorably employed as the light emitting elements in the planar light emitting element arrays.

Still further, it is desirable that the exposure head of the present invention further comprises:
a magnifying/focusing optical system, for focusing an image formed by the planar light emitting element array on the photosensitive material at 1× magnification. In this case, a gradient index lens array may be favorably employed as the magnifying/focusing optical system.

Meanwhile, the exposure apparatus according to the present invention is that for exposing two dimensional images on photosensitive material, comprising:
an exposure according to the present invention, having the structure described above; and
a sub scanning means, for moving the exposure head and the photosensitive material relative to each the in the sub scanning direction.

In the planar light emitting element array that constitutes the exposure head of the present invention, the relationships P1≦2a and P2≦2b are satisfied. That is, the gaps between the light emitting elements are smaller than the sizes thereof in both the main and sub scanning directions. Therefore, it is possible to arrange a great number of the light emitting elements at high density. Therefore, the exposure head realizes sufficiently high pixel density without particularly miniaturizing the light emitting elements, while being small in size itself.

In the case that the exposure head according to the present invention also satisfies the relationships a<b and P1=b, the size of the light emitting elements is larger in the sub scanning direction than in the main scanning direction, while the arrangement pitch in the main scanning direction is equal to the size of the light emitting elements in the sub scanning direction. Thereby, the pixel resolution of an exposed image will be equal in both the main and sub scanning directions.

Note that the amount of exposure light that the photosensitive material receives from each of the light emitting elements of the planar light emitting element array is maximal at the portions that face the centers of the light emitting elements. The amount of exposure light that the photosensitive material receives from each of the light emitting elements is less than the maximal amount, at the portions that face the edges of the light emitting elements. Accordingly, in the case that an exposure apparatus, that employs this type of exposure head and performs sub scanning, exposes one main scanning line with a single linear light emitting element array, the amount of exposure light along the main scanning direction fluctuates periodically a great deal, corresponding to the arrangement pitch of the light emitting elements. In the case that the periodic fluctuation of the amount of exposure light is conspicuous, uneven exposure may occur in the main scanning direction.

In view of these circumstances, in a preferred configuration of the exposure head according to the present invention, at least a portion of the light emitting elements of adjacent linear light emitting element arrays are shifted and overlap in the main scanning direction. In the case that such a configuration is adopted, the periodic fluctuation properties of the amount of exposure light from one linear light emitting element array is shifted from that of an adjacent linear light emitting element array, in the main scanning direction. Therefore, portions may receive less exposure light from one linear light emitting element array of one main scanning line, which is exposed by a plurality of linear light emitting element arrays. However, these portions receive more exposure light from a linear light emitting element array adjacent to the one linear emitting element array. Therefore, the periodic fluctuations in the amount of exposure light cancel each other out, and uneven exposure in the main scanning direction is prevented.

In addition, a configuration may be adopted wherein:
a plurality of the planar light emitting element arrays, each having light emitting elements that emit light at different spectrums, are employed; and
the plurality of planar light emitting element arrays are arranged in the sub scanning direction. In this case, images having a plurality of colors are enabled to be exposed on a color photosensitive material. Particularly, in the case that the spectrums of light emitted from the light emitting elements of the planar light emitting element arrays are in the R (red), G (green), and B (blue) regions, respectively, full color images are enabled to be exposed.

Further, elements that constitute the aforementioned organic EL elements are capable of being formed as a uniform film by conventional film forming methods, such as a vacuum vapor deposition method. Accordingly, in the case that the organic EL elements are employed as light emitting elements of the planar light emitting element arrays, production of the planar light emitting elements is facilitated. In addition, fluctuations in the properties and degradation rates among each of the light emitting elements are enabled to be suppressed.

Meanwhile, the exposure apparatus according to the present invention comprises the exposure head of the present invention, which is capable of densely arranging a great number of light emitting elements and being small in size. Therefore, the exposure apparatus is capable of exposing highly detailed images, while being small in size and producible at low cost.

### BRIEF DESCRIPTION OF THE DRAWINGS

FIG. 1 is a side view of an exposure apparatus, which comprises an exposure head according to a first embodiment of the present invention.

FIG. 2 is a schematic plan view of the exposure head illustrated in FIG. 1.

FIG. 3 is a schematic view that illustrates the arrangement state of red light emitting elements of the exposure head illustrated in FIG. 1.

FIG. 4 is a schematic view that illustrates the arrangement state of green light emitting elements of the exposure head illustrated in FIG. 1.

FIG. 5 is a schematic view that illustrates the arrangement state of blue light emitting elements of the exposure head illustrated in FIG. 1.

### DESCRIPTION OF THE PREFERRED EMBODIMENTS

Hereinafter, an embodiment of the present invention will be described with reference to the attached drawings.

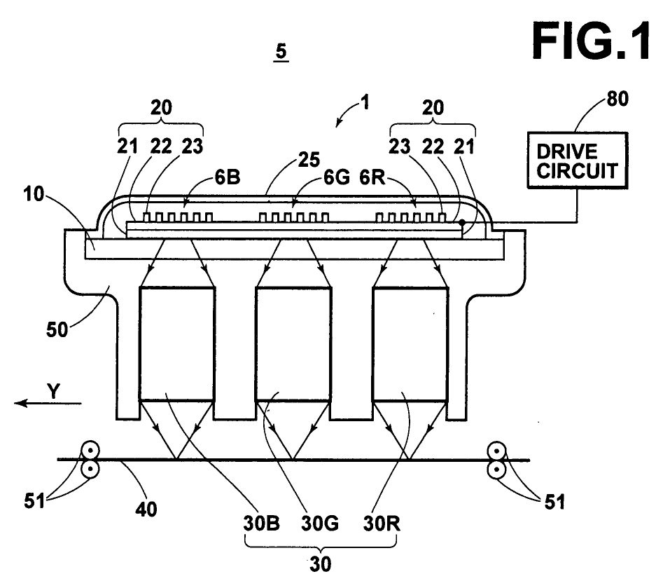

FIG. 1 is a side view of an exposure apparatus 5, which comprises an exposure head 1 according to a first embodiment of the present invention. As illustrated in FIG. 1, the exposure head 1 according to the first embodiment comprises: a transparent substrate 10; a great number of organic EL elements 20, which are formed on the transparent substrate 10 by vapor deposition; a gradient index lens array 30 (30R, 30G, and 30B) as a magnifying/focusing optical system, for focusing images formed by the light emitted from the organic EL elements 20 on a color photosensitive material 40; and a support 50 for supporting the transparent substrate 10 and the gradient index lens array 30.

The exposure apparatus 5 further comprises a sub scanning means 51, constituted by nip rollers or the like, for conveying the color photosensitive material 40 at a constant speed in the direction indicated by arrow Y, in addition to the exposure head 1.

The organic EL elements 20 are formed by stacking an organic compound layer 22, which includes a transparent anode 21 and a light emitting layer, and a metallic cathode 23 in this order on the transparent substrate 10 by vapor deposition. The organic EL elements 20 are patterned in single pixel units on the transparent substrate 10, which is formed by glass or the like. The elements that constitute the organic EL elements 20 are provided within a sealing member 25, formed by a stainless steel can or the like. That is, the edges of the sealing member 25 and the transparent substrate 10 are adhesively attached, and the organic EL elements 20 are sealed within an atmosphere of dry nitrogen gas in the interior of the sealing member 25.

When a predetermined voltage is applied between the transparent anode 21 and the metallic cathode 23, the light emitting layer, which is included within the organic compound layer 22, emits light. The emitted light is output via the transparent anode 21 and the transparent substrate 10. The organic EL elements 20 of this type exhibit superior wavelength stability properties. Note that the arrangement state of the organic EL elements will be described in detail later.

Here, it is preferable that the transparent anodes 21 have a transmissivity of at least 50%, with respect to visible light within a wavelength range of 400 nm to 700 nm. It is more preferable that the transparent anodes 21 have a transmissivity of at least 70% with respect to visible light within the wavelength range of 400 nm to 700 nm. Known compounds, such as Tin oxide, Indium Tin Oxide (ITO), and indium zinc oxide may be employed as the material of the transparent anodes 21. Alternatively, thin films of metals having high work functions, such as gold and platinum, may be employed as the material of the transparent anodes 21. Organic compounds, such as polyanilene, polythiophene and polypyrrole, and dielectrics thereof may also be employed. Note that transparent conductive films are described in detail in “Developments in Transparent Conductive Films”, Y. Sawada Ed., CMC Publishing, 1999, and it is possible to apply those described in therein to the present invention. The transparent anodes 21 may be formed on the transparent substrate 10 by a vacuum vapor deposition method, a sputtering method, an ion plating method, and the like.

Meanwhile, the organic compound layer 22 may be of a single layer structure comprising only the light emitting layer. Alternatively, a multiple layer structure, wherein a hole insertion layer, a hole transport layer, an electron insertion layer, an electron transport layer and the like are provided, may be adopted. An anode/hole insertion layer/hole transport layer/light emitting layer/electron transport layer/cathode structure, an anode/light emitting layer/electron transport layer/cathode structure, and an anode/hole transport layer/light emitting layer/electron transport layer/cathode structure are specific examples of the layer structure of the organic compound layer 22 and electrodes. Pluralities of the light emitting layer, the hole transport layer, the hole insertion layer, and the electron insertion layer may be provided.

Preferred materials of the metallic cathode 23 are alkaline metals having low work functions such as Li and K, alkaline earth metals such as Mg and Ca, and compounds or alloys in which Li, K, Mg, or Ca are combined with Ag, Al, and the like. Electrode's formed by the aforementioned materials may be coated with highly conductive metals having high work functions, such as Ag, Al, Au and the like. The coating is provided in order to realize both storage stability and electron insertion properties of the cathode. Note that the metallic cathode 23 may be formed by a known method, such as a vacuum vapor deposition method, a sputtering method, an ion plating method or the like, in the same manner as the transparent anode 21.

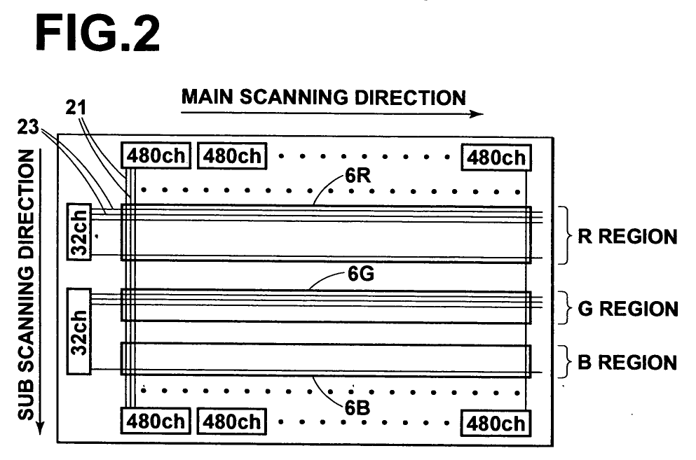

Next, the arrangement state of the organic EL elements 20 will be described in detail. FIG. 2 illustrates the arrangement state of the transparent anodes 21 and the metallic cathodes 23 on the exposure head 1. As illustrated in FIG. 2, the transparent anodes 21 are patterned to extend substantially in the sub scanning direction, and serve as common electrodes for the organic EL elements 20, which are arranged in this direction. In the present embodiment, 3,840 (480×8) transparent anodes 21 are arranged in the main scanning direction. On the other hand, the metallic cathodes 23 are patterned to extend in the main scanning direction, ad serve as common electrodes for the organic EL elements 20, which are arranged in this direction. In the present embodiment, 64 metallic cathodes 23 are arranged in the sub scanning direction.

The transparent anodes 21 and the metallic cathodes 23 are arranged as so-called column electrodes and row electrodes, respectively. Predetermined voltages are applied between the transparent anodes 21 and the metallic cathodes 23, which are selected according to image signals, by a drive circuit 80 illustrated in FIG. 1. Thereby, the light emitting layer, which is included organic compound layer 22, layered at the intersections of the transparent anodes 21 and metallic cathodes 23, between which voltages are applied, emits light. The emitted light is output from the side of the transparent substrate 10. That is, in the present embodiment, a single organic EL element 20 is constituted in units of the intersecting portions of the transparent anodes 21 and the metallic cathodes 23. Linear, light emitting element arrays are constituted by the plurality of organic EL elements 20, which are arranged in the main scanning direction at a predetermined pitch. Planar light emitting element arrays are constituted by the plurality of linear light emitting element arrays, which are arranged in the sub scanning direction.

Note that in the present embodiment, a passive matrix drive method is employed, as described above. A detailed description of this drive method will be omitted, because driving, employing this method, may be performed by known methods. However, the present invention is not limited to the passive matrix drive method. An active matrix drive method that employs switching elements, such as TFT's (Thin Film Transistors) may be employed as an alternative.

Here, the exposure head 1 of the present embodiment is formed to be capable of exposing full color images on color photosensitive material 40, such as silver halide color paper. Hereinafter, the structure that enables such exposure will be described in detail.

The organic EL elements 20 include organic EL elements 20R, 20G, and 20B. The organic EL elements 20R emit red light, the organic EL elements 20G emit green light, and the organic EL elements 20B emit blue light. The different colors are emitted according to the composition of the light emitting layer, which is included in the organic compound layer 22.

The organic EL elements 20R are provided in the region labeled “R Region” in FIG. 2. One linear red light emitting element array is constituted by 3,840 organic EL elements 20R, which are arranged in the main scanning direction. 32 linear red light emitting elements are arranged in the sub scanning direction, to constitute a planar red light emitting element array 6R.

The organic EL elements 20G are provided in the region labeled “G Region” in FIG. 2. One linear green light emitting element array is constituted by 3,840 organic EL elements 20G, which are arranged in the main scanning direction. 16 linear green light emitting elements are arranged in the sub scanning direction, to constitute a planar green light emitting element array 6G.

The organic EL elements 20B are provided in the region labeled “B Region” in FIG. 2. One linear blue light emitting element array is constituted by 3,840 organic EL elements 20B, which are arranged in the main scanning direction. 16 linear blue light emitting elements are arranged in the sub scanning direction, to constitute a planar blue light emitting element array 6B.

Note that only six colored linear light emitting element arrays, which constitute each of the planar red light emitting element array 6R, the planar green light emitting element array 6G, and the planar blue light emitting element array 6B, are illustrated in FIG. 1, for the sake of convenience.

In the exposure apparatus 5 illustrated in FIG. 1, the planar red light emitting element array 6R, the planar green light emitting element array 6G, and the planar blue light emitting element array 6B are driven by the drive circuit 80, based on red image data, green image data, and blue image data, during image exposure of the color photosensitive material 40. At the same time, the sub scanning means 51 conveys the color photosensitive material 40 in the sub scanning direction indicated by the arrow Y at a constant speed.

At this time, an image formed by the red light emitted from the 32 linear red light emitting element arrays of the planar red light emitting element array 6R, an image formed by the green light emitted from the sixteen linear green light emitting element arrays of the planar green light emitting element array 6G, and an image formed by the blue light emitted from the sixteen linear blue light emitting element arrays of the planar blue light emitting element array 6B are focused on the color photosensitive material 40 at 1× magnification by the gradient index lens arrays 30R, 30G, and 30B, respectively. Thereby, a portion of the color photosensitive material 40, which is first exposed by the red light emitted from the 32 linear red light emitting element arrays, is sequentially exposed by the green light emitted from the sixteen linear green light emitting element arrays and by the blue light emitted from the sixteen linear blue light emitting element arrays. Full color main scanning lines, which are formed in this manner, are sequentially formed in the sub scanning direction accompanying the conveyance of the color photosensitive material 40. Thereby, full color two dimensional images are exposed on the color photosensitive material 40.

Note that a gradient index lens formed by a Selfoc™ lens may be provided for each organic EL element 20R, to constitute the gradient index lens array 30R. The same configuration may be adopted for the gradient index lens arrays 30G and 30B.

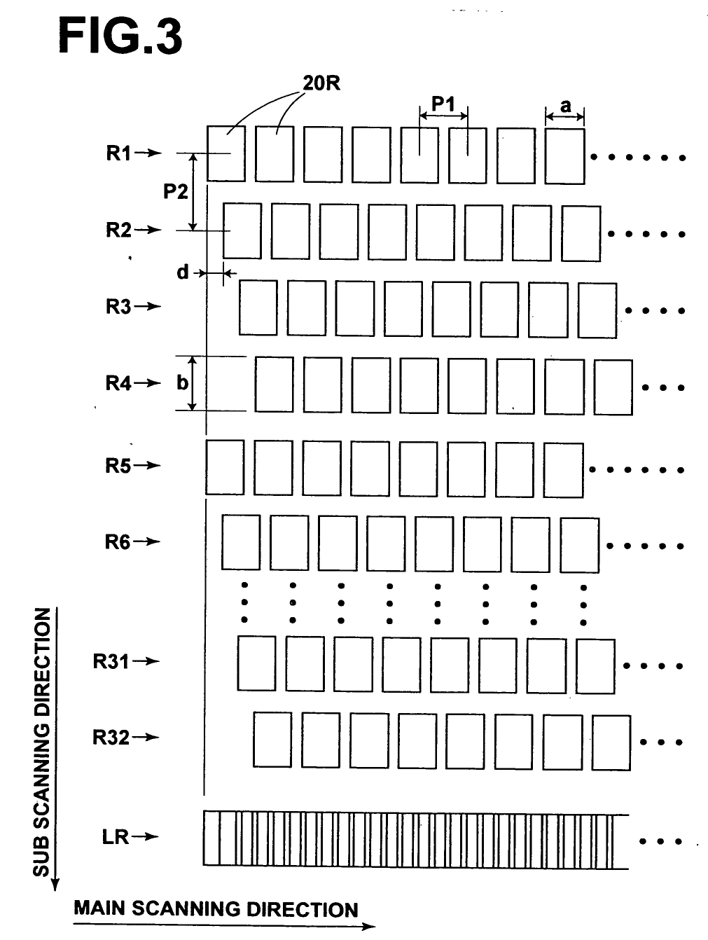

Next, the planar light emitting element arrays 6R, 6G, and 6B will be described in further detail. First, the planar red light emitting element array 6R, illustrated in FIG. 3, will be described. Here, each of the 32 linear red light emitting element arrays that constitute the planar red light emitting element array 6R are labeled sequentially in the sub scanning direction as R1, R2, R3, . . . R32. The linear red light emitting element arrays are arranged as illustrated in FIG. 3. The sizes of all of the organic EL elements 20R, which constitute each of the linear red light emitting element arrays R1 through R32, are a in the main scanning direction and b in the sub scanning direction. The pitches among all of the organic EL elements 20R are P1 in the main scanning direction, and P2 in the sub scanning direction.

The linear red light emitting element arrays R2, R3, and R4 are shifted in the main scanning direction for distances of d, 2 d, and 3 d, respectively, with respect to the linear red light emitting element array R1. The next linear red light emitting element array, R5, is aligned with the linear red light emitting element array R1 in the main scanning direction. The arrangement, in which the linear red light emitting element arrays are shifted from each other in the main scanning direction, is repeated for every four linear red light emitting element arrays thereafter. Therefore, the main scanning lines LR of the color photosensitive material 40, which is exposed by red light, are constituted by pluralities of pixels, which are arranged at ¼ the pitch P1 among the organic EL elements 20R, in the main scanning direction.

As is clear from the description above, the first pixels of the main scanning lines LR are exposed by the first organic EL element 20R of the linear red light emitting element arrays R1, R5, R9, R13, R17, R21, R25, and R29. The second pixels of the main scanning lines LR are exposed by the first organic EL element 20R of the linear red light emitting element arrays R2, R6, R10, R14, R18, R22, R26, and R30. The third pixels of the main scanning lines LR are exposed by the first organic EL element 20R of the linear red light emitting element arrays R3, R7, R11, R15, R19, R23, R27, and R31. The fourth pixels of the main scanning lines LR are exposed by the first organic EL element 20R of the linear red light emitting element arrays R4, R8, R12, R16, R20, R24, R28, and R32. The fifth pixels of the main scanning lines LR are exposed by the second organic EL element 20R of the linear red light emitting element arrays R1, R5, R9, R13, R17, R21, R25, and R29. In a similar manner, each of the remaining pixels of the main scanning lines LR are exposed by eight organic EL elements 20R. The eight organic EL elements 20R that expose each pixel are caused to emit light in pulses. Each pixel may have gradation therein, by controlling the pulse lengths of light emission, for example. Thereby, an image having continuous gradation is capable of being exposed on the color photosensitive material 40.

Note that the amount of exposure light that the color photosensitive material 40 receives from each organic EL element 20R is maximal at the center of the organic EL element 20R. The amount of exposure light that the color photosensitive material 40 receives from each organic EL element 20R is less than the maximal amount, at the portions that face the edges of the organic EL elements. Accordingly, in the case that exposure is performed on one main scanning line with a single linear light emitting element array, the amount of exposure light along the main scanning direction fluctuates periodically a great deal, corresponding to the arrangement pitch of the organic EL elements 20R. In the case that the periodic fluctuation (ripple) of the amount of exposure light is conspicuous, there is a possibility that uneven exposure will occur in the main scanning direction.

To solve this problem, at least a portion of the organic EL elements 20R of adjacent linear red light emitting element arrays are shifted and overlap in the main scanning direction in the present embodiment, as described above. That is, the periodic fluctuation properties of the amount of exposure light from one linear red light emitting element array is shifted from that of an adjacent linear red light emitting element array, in the main scanning direction. Therefore, portions may receive less exposure light from one linear red light emitting element array of one main scanning line, which is exposed by a plurality of linear red light emitting element arrays. However, these portions receive more exposure light from a linear red light emitting element array adjacent to the one linear red emitting element array. Therefore, the periodic fluctuations in the amount of exposure light cancel each other out as a whole, and uneven exposure in the main scanning direction is prevented. Note that techniques for suppressing the periodic fluctuations in the amount of exposure light are described in detail in U.S. patent Laid-Open No. 20010052926.

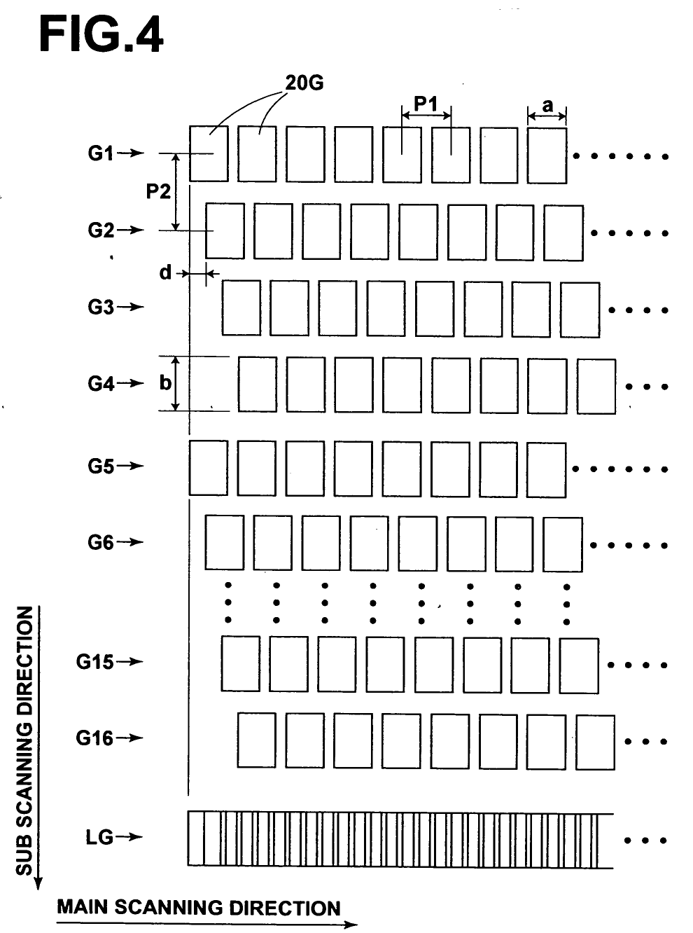

Next, the planar green light emitting element array 6G will be described in further detail, with reference to FIG. 4. Here, each of the sixteen linear green light emitting element arrays that constitute the planar green light emitting element array 6G are labeled sequentially in the sub scanning direction as G1, G2, G3, . . . G16. The linear green light emitting element arrays are arranged as illustrated in FIG. 4. The sizes of all of the organic EL elements 20G, which constitute each of the linear green light emitting element arrays G1 through G16, are a in the main scanning direction and b in the sub scanning direction. The pitches among all of the organic EL elements 20G are P1 in the main scanning direction, and P2 in the sub scanning direction.

The linear green light emitting element arrays G2, G3, and G4 are shifted in the main scanning direction for distances of d, 2 d, and 3 d, respectively, with respect to the linear green light emitting element array G1. The next linear green light emitting element array, G5, is aligned with the linear green light emitting element array G1 in the main scanning direction. The arrangement, in which the linear green light emitting element arrays are shifted from each other in the main scanning direction, is repeated for every four linear green light emitting element arrays thereafter. Therefore, the main scanning lines LG of the color photosensitive material 40, which is exposed by green light, are constituted by pluralities of pixels, which are arranged at ¼ the pitch P1 among the organic EL elements 20G, in the main scanning direction.

As is clear from the description above, the first pixels of the main scanning lines LG are exposed by the first organic EL element 20G of the linear green light emitting element arrays G1, G5, G9, and G13. The second pixels of the main scanning lines LG are exposed by the first organic EL element 20G of the linear green light emitting element arrays G2, G6, G10, and G14. The third pixels of the main scanning lines LG are exposed by the first organic EL element 20G of the linear green light emitting element arrays G3, G7, G11, and G15. The fourth pixels of the main scanning lines LG are exposed by the first organic EL element 20G of the linear green light emitting element arrays G4, G8, G12, and G16. The fifth pixels of the main scanning lines LG are exposed by the second organic EL element 20G of the linear green light emitting element arrays G1, G5, G9, and G13. In a similar manner, each of the remaining pixels of the main scanning lines LG are exposed by four organic EL elements 20G.

Regarding the points of causing each pixel to have gradation therein by controlling the drive of the organic EL elements, and of suppressing periodic fluctuation (ripple) of the amount of exposure light in the main scanning direction in the planar green light emitting element array 6G, the same methods that are employed for the planar red light emitting element array 6R may be employed.

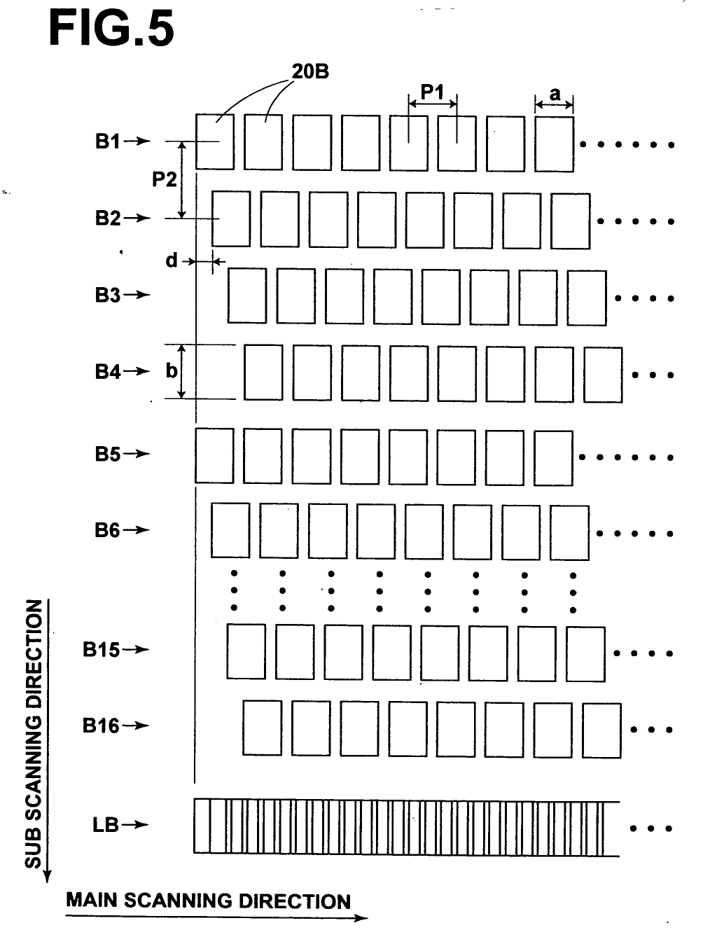

Next, the planar blue light emitting element array 6B will be described in further detail, with reference to FIG. 5. Here, each of the sixteen linear blue light emitting element arrays that constitute the planar blue light emitting element array 6B are labeled sequentially in the sub scanning direction as B1, B2, B3, . . . B16. The linear blue light emitting element arrays are arranged as illustrated in FIG. 5. The sizes of all of the organic EL elements 20B, which constitute each of the linear blue light emitting element arrays B1 through B16, are a in the main scanning direction and b in the sub scanning direction. The pitches among all of the organic EL elements 20B are P1 in the main scanning direction, and P2 in the sub scanning direction. That is, the sizes of the elements and their arrangement pitches are the same as those of the organic EL elements 20R and 20G.

The linear blue light emitting element arrays B2, B3, and B4 are shifted in the main scanning direction for distances of d, 2 d, and 3 d, respectively, with respect to the linear blue light emitting element array B1. The next linear blue light emitting element array, B5, is aligned with the linear blue light emitting element array B1 in the main scanning direction. The arrangement, in which the linear blue light emitting element arrays are shifted from each other in the main scanning direction, is repeated for every four linear blue light emitting element arrays thereafter. Therefore, the main scanning lines LB of the color photosensitive material 40, which is exposed by blue light, are constituted by pluralities of pixels, which are arranged at ¼ the pitch P1 among the organic EL elements 20B, in the main scanning direction.

As is clear from the description above, the first pixels of the main scanning lines LB are exposed by the first organic EL element 20B of the linear blue light emitting element arrays B1, B5, B9, and B13. The second pixels of the main scanning lines LB are exposed by the first organic EL element 20B of the linear blue light emitting element arrays B2, B6, B10, and B14. The third pixels of the main scanning lines LB are exposed by the first organic EL element 20B of the linear blue light emitting element arrays B3, B7, B11, and B15. The fourth pixels of the main scanning lines LB are exposed by the first organic EL element 20B of the linear blue light emitting element arrays B4, B8, B12, and B16. The fifth pixels of the main scanning lines LB are exposed by the second organic EL element 20B of the linear blue light emitting element arrays B1, B5, B9, and B13. In a similar manner, each of the remaining pixels of the main scanning lines LB are exposed by four organic EL elements 20B.

Regarding the points of causing each pixel to have gradation therein by controlling the drive of the organic EL elements, and of suppressing periodic fluctuation (ripple) of the amount of exposure light in the main scanning direction in the planar green light emitting element array 6B, the same methods that are employed for the planar red light emitting element array 6R may be employed.

Next, the sizes a and b of the organic EL elements 20R, 20G, and 20B in the main and sub scanning directions, as well as the arrangement pitches P1 and P2 in the main and sub scanning directions will be described. Note that here, the organic EL elements 20R, 20G, and 20B will collectively be referred to as “organic EL elements 20”.

In the exposure head 1 of the present embodiment, a=34 μm, b=42.4 μm, P1=42.4 μm, and P2=63.5 μm. The amount of shift d, among adjacent linear light emitting element arrays illustrated in FIGS. 3 through 5, is P1/4=10.6 μm. Accordingly, the present embodiment satisfies the aforementioned relationships P1≦2a and P2≦2b. That is, the gaps among the organic EL elements 20 are smaller than the sizes thereof in both the main and sub scanning directions. Therefore, a great number of the organic EL elements 20 may be arranged at high density. The exposure head 1 is capable of achieving sufficiently high pixel density without particularly decreasing the size of the organic EL elements 20, and is capable of being small in size itself.

Further, the present embodiment satisfies the relationships a<b and P1=b. That is, the size of the organic EL elements 20 is greater in the sub scanning direction than in the main scanning direction, and the arrangement pitch in the main scanning direction is equal to the size in the sub scanning direction. Therefore, the pixel resolution of exposed images is equal in the main and sub scanning directions. In the present example, the pixel resolution is 600 dpi (dots per inch).

Note that it is desirable that the aforementioned amount of shift d is set to d=P1·m/n, wherein n (a natural number 2 or greater) is the number of linear light emitting element arrays, m is a number that satisfies the condition: 1≦m≦n, and n/m is a natural number. This is to ensure uniform exposure of the photosensitive material by a plurality of linear light emitting element arrays.

Next, an exposure head according to a second embodiment of the present invention will be described. The exposure apparatus of the second embodiment shares the same basic structure with the exposure head 1 of the first embodiment. However, the sizes a and b of the organic EL elements 20 in the main and sub scanning directions, and the arrangement pitches P1 and P2 in the main and sub scanning directions are different. That is, in the second embodiment, a=b=85 μm, P1=127 μm, and P2=95 μm. The amount of shift d, among adjacent linear light emitting element arrays, is P1/4=31.75 μm.

Accordingly, the second embodiment also satisfies the relationships P1≦2a and P2≦2b. Therefore, the exposure head of the second embodiment is capable of achieving sufficiently high pixel density without particularly decreasing the size of the organic EL elements 20, and is capable of being small in size itself, in the same manner as that of the first embodiment.

Hereinafter, the pixel densities of the embodiments above will be compared against those of conventional exposure heads. Here, pixel density is defined by an aperture ratio, which is expressed by: (a×b)/(P1×P2). The aperture ratio is 53.3% in the first embodiment, and 59.9% in the second embodiment. A case is considered, in which the circular light emitting elements disclosed in U.S. Patent laid-Open No. 20010052926 are employed. In this case, the diameter D of the light emitting elements is 85 μm, P1 is 190.5 μm, and P2 is 127 μm. Therefore, the aperture ratio is 23.4% (πD²/4)/(P1×P2). That is, the first and second embodiments of the present invention achieve over double the pixel density of conventional exposure heads.

Note that in the above embodiments, the linear red light emitting element array R1, the linear green light emitting element array G1, and the linear blue light emitting element array B1 are aligned in the main scanning direction. That is, the four arrangement patterns of the linear light emitting element arrays within the planar light emitting element arrays are aligned with each other. However, the present invention is not limited to such a configuration. The linear red light emitting element array R1, the linear green light emitting element array G1, and the linear blue light emitting element array B1 may be shifted within an allowable range for color shifting. By adopting this configuration, the aforementioned uneven exposure can be further suppressed.

Further, in the above embodiments, the arrangement patterns of the light emitting elements are the same among the planar red light emitting element array 6R, the planar green light emitting element array 6G, and the planar blue light emitting element array 6B. However, the present invention is not limited to this configuration. The light emitting element arrays for each color may employ different arrangement patterns of the light emitting elements. In this case as well, the aforementioned effects can be obtained, as long as each of the light emitting element arrays satisfies the relationships P1≦2a, P2≦2b, a<b, and P1=b.

The various relationships described above need not be satisfied among the planar red light emitting element array 6R, the planar green light emitting element array 6G, and the planar blue light emitting element array 6B.

The exposure heads of the above embodiments expose photosensitive material with red, green, and blue light. However, it is possible to expose photosensitive material with other colors, such as cyan, magenta, and yellow, according to the properties thereof. Further, the number of colors of the exposure light is not limited to three. In the case that full color images are exposed, four colors may be employed. In the case that color images, which are not full color images, are exposed, two colors may be employed. In the case that black and white images are exposed, a single color may be employed.

In the above embodiments, the shape of the organic EL elements is rectangular. However, the shape of the light emitting elements of the exposure head according to the present invention is not limited to being rectangular. Circular or ellipsoidal light emitting elements may alternatively be used. However, from the viewpoint of increasing the pixel aperture ratio, it is desirable that the light emitting elements are rectangular or square.

It goes without saying that the planar light emitting element arrays may employ light emitting elements other than organic EL elements. It is possible to employ combinations of shutter arrays, such as crystal shutter arrays and PLZT shutter arrays, and backlights. Alternatively, LED arrays, combinations of LED arrays and aperture masks, inorganic EL elements, VFPH elements, or DLP elements maybe employed.

1. An exposure head for exposing photosensitive material, comprising:
a plurality of linear light emitting element arrays, in each of which a plurality of light emitting elements are arranged in a main scanning direction at a predetermined pitch; and
a planar light emitting element array, comprising the plurality of linear light emitting element arrays, which are arranged in a sub scanning direction substantially perpendicular to the main scanning direction; wherein
the size a of each light emitting element in the main scanning direction and the pitch P1, at which they are arranged in the main scanning direction, satisfy the relationship:
P1≦2a; and
the size b of each light emitting element in the sub scanning direction and the pitch P2, at which they are arranged in the sub scanning direction, satisfy the relationship:
P2≦2b.

2. An exposure head as defined in claim 1, wherein:
the relationships:
a<b and P1=b are satisfied.

3. An exposure head as defined in claim 1, wherein:
at least a portion of the light emitting elements of adjacent linear light emitting element arrays are shifted and overlap in the main scanning direction.

4. An exposure head as defined in claim 1, wherein:
a plurality of the planar light emitting element arrays, each having light emitting elements that emit light at different spectrums, are employed; and
the plurality of planar light emitting element arrays are arranged in the sub scanning direction.

5. An exposure head as defined in claim 4, wherein:
the spectrums of light emitted from the light emitting elements of the planar light emitting element arrays are in the R (red), G (green), and B (blue) regions, respectively.

6. An exposure head as defined in claim 1, wherein:
the light emitting elements are organic EL elements.

7. An exposure head as defined in claim 1, further comprising:
a magnifying/focusing optical system, for focusing an image formed by the planar light emitting element array on the photosensitive material at 1× magnification.

8. An exposure head as defined in claim 7, wherein:
the magnifying/focusing optical system comprises a gradient index lens array.

9. An exposure apparatus for exposing two dimensional images on photosensitive material, comprising:
an exposure head comprising a plurality of linear light emitting element arrays, in each of which a plurality of light emitting elements are arranged in a main scanning direction at a predetermined pitch; and a planar light emitting element array, comprising the plurality of linear light emitting element arrays, which are arranged in a sub scanning direction substantially perpendicular to the main scanning direction; wherein the size a of each light emitting element in the main scanning direction and the pitch P1, at which they are arranged in the main scanning direction, satisfy the relationship: P1≦2a; and the size b of each light emitting element in the sub scanning direction and the pitch P2, at which they are arranged in the sub scanning direction, satisfy the relationship: P2≦2b; and
a sub scanning means, for moving the exposure head and the photosensitive material relative to each the in the sub scanning direction.

10. An exposure apparatus as defined in claim 9, wherein:
the exposure head satisfies the relationships:
a<b and P1=b.

11. An exposure apparatus as defined in claim 9, wherein:
at least a portion of the light emitting elements of adjacent linear light emitting element arrays are shifted and overlap in the main scanning direction.

12. An exposure apparatus as defined in claim 9, wherein:
a plurality of the planar light emitting element arrays, each having light emitting elements that emit light at different spectrums, are employed; and
the plurality of planar light emitting element arrays are arranged in the sub scanning direction.

13. An exposure apparatus as defined in claim 12, wherein:
the spectrums of light emitted from the light emitting elements of the planar light emitting element arrays are in the R (red), G (green), and B (blue) regions, respectively.

14. An exposure apparatus as defined in claim 9, wherein:
the light emitting elements are organic EL elements.

15. An exposure apparatus as defined in claim 9, further comprising:
a magnifying/focusing optical system, for focusing an image formed by the planar light emitting element array on the photosensitive material at 1× magnification.

16. An exposure apparatus as defined in claim 15, wherein:
the magnifying/focusing optical system comprises a gradient index lens array.
